(19) United States
(12) Patent Application Publication
(10) Pub. No.: US 2006/0209260 A1
(43) Pub. Date: Sep. 21, 2006

(54) Scrolling picture changer

(76) Inventor: Timothy Clegg, Manhattan Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/081,488

(22) Filed: Mar. 16, 2005

(51) Int. Cl. G03B 25/00

(52) U.S. Cl. 352/98

(57) ABSTRACT

A scrolling picture changer comprising an enveloping member having a window for displaying an image. The image sheet has two images, namely a first image and a second image to be displayed in the window. The image sheet is connected to the inside of the envelope at an image sheet upper end and an image sheet lower end. A buckle has a slot in the buckle, the image sheet passes through the slot. The slot in the buckle defines the image interface between the first image and second image. A tab sheet is partially connected to the image member at the middle of the image sheet between the first picture and second picture. A user pulling on the tab will scroll the picture and transform the first picture to the second picture. When the image is in initial position, only the first image is shown in the window.

### BACKGROUND

In the field of direct marketing, nothing is more important than enticing a recipient of a direct marketing piece to actually open the piece and see what is inside. Usually such enticement is in the form of a printed message on the outside of the envelope, with a message about saving money or some other incentive. Other times a marketer will put nothing on the outside of the envelope that would give any indication as to the source of the mailing, a technique that relies on generating curiosity within the recipient as to what might be inside the envelope. Similarly, offers will sometimes appear to be overtly valuable, such as including a promising marketing piece resembling a bank draft visible beneath the window of the envelope, perhaps even going so far as to print in a visible way “Pay to the order of” along with the recipient's name and address.

All of these techniques have met with some amount of success at increasing the response rate of direct mail campaigns. Novelty and generating curiosity within the recipient tends to generate superior response, merely because the recipient desires to know how something works.

### BRIEF DESCRIPTION OF THE DRAWINGS

FIG. 1 is a scrolling picture changer in first position.

FIG. 2 is a scrolling picture changer in intermediate position.

FIG. 3 is a scrolling picture changer in intermediate position.

FIG. 4 is a scrolling picture changer in intermediate position.

FIG. 5 is a scrolling picture changer in second position.

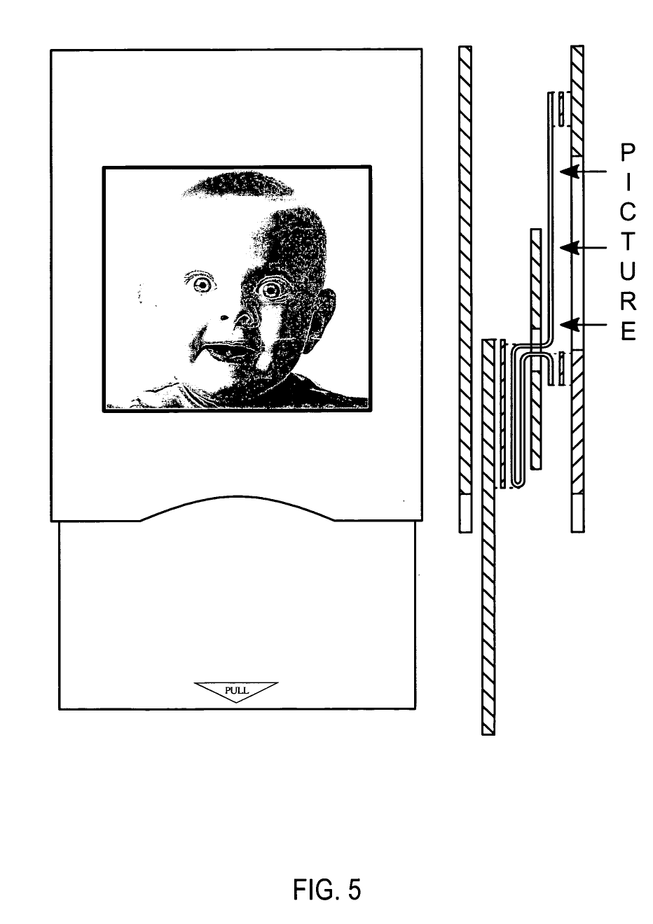

### DETAILED DESCRIPTION OF THE PREFERRED EMBODIMENT

The scrolling picture changer can be incorporated in a variety of applications. Some of these applications include, scrolling picture changer greeting cards, scrolling picture changer direct mail advertising pieces, scrolling picture changer billboards, and scrolling picture changer trade show booth displays. Although the figures and present embodiment shows a generally rectangular device, the device can also be made in nonrectangular configurations.

The scrolling picture changer is preferably made of paper, but can also be made of plastic or other flexible planar materials. When the user pulls the tab, the picture scrolls and it changes from the first image to a second image. The user may push the pull-tab back into the envelope and revert to the image to the first image.

Looking at figure one, the device 10 is shown with a front view of the device showing the initial image 110 and a correspondent cross section view to the right of the front view. The image 110 faces right in the cross section view. From right to left on the exploded cross section view, the elements of the scrolling picture changer include an enveloping member 120 such as an envelope having a window 111 for displaying an image 111. The enveloping member or envelope can be two sheets joined at an edge forming a space between the sheets so that a generally planar cavity 80 allows moving sheet components inside to slide about. The enveloping member 120 or envelope 120 does not refer to the kind commonly used for mailing and can be made of several joined sheets or a single sheet of paper or plastic.

The image is displayed on the image member. The image member is partially connected to the push and pull-tab 130 also known as the tab sheet 130 preferably by glue or double sided adhesive tape 135 forming the image tab junction 135. The tab sheet 130 preferably protrudes from the bottom of the envelope so that a user can grab the tab sheet 130. The tab sheet 130 can also protrude from the top of the envelope or the side of the envelope. The tab sheet 130 when protruding from the side of the envelope can protrude from both sides of the envelope 120 so that no torque, rotational misalignment is applied to the buckle 150. Because the buckle is formed as a sheet, the buckle sheet may not necessarily be constrained within the envelope. The buckle should not rotate unless such rotation is intended. When the envelope has a sheet protruding from the bottom, the bottom can be left open. When the envelope has a sheet protruding from the top, the top can be left open.

The image member 112 or sheet 112 has a first picture 110 that is shown in the window in figure one. As seen in figure one, the image sheet is glued or taped or otherwise connected to the inside of the envelope at an image sheet upper end and an image sheet lower end. The image sheet passes through a slot 155 in the buckle 150. The buckle is not glued to other sheets. When the user moves the tab, the buckle floats freely sliding inside of the envelope. Slack in the image sheet allows the image sheet to pass through the slot in the buckle. Preferably, the slack portion of the image sheet passes through the slot in the buckle. The slack may be the length of an image.

The image sheet has both of the pictures printed on it. The bottom half of the image sheet has the first picture 110, and the top half of the image sheet has the second picture 114. The image sheet is glued in the middle to the tab sheet so that a user pulling on the tab will begin to scroll the image and to transform the first image to the second image. The image is in the initial position in figure one so that none of the second image is shown.

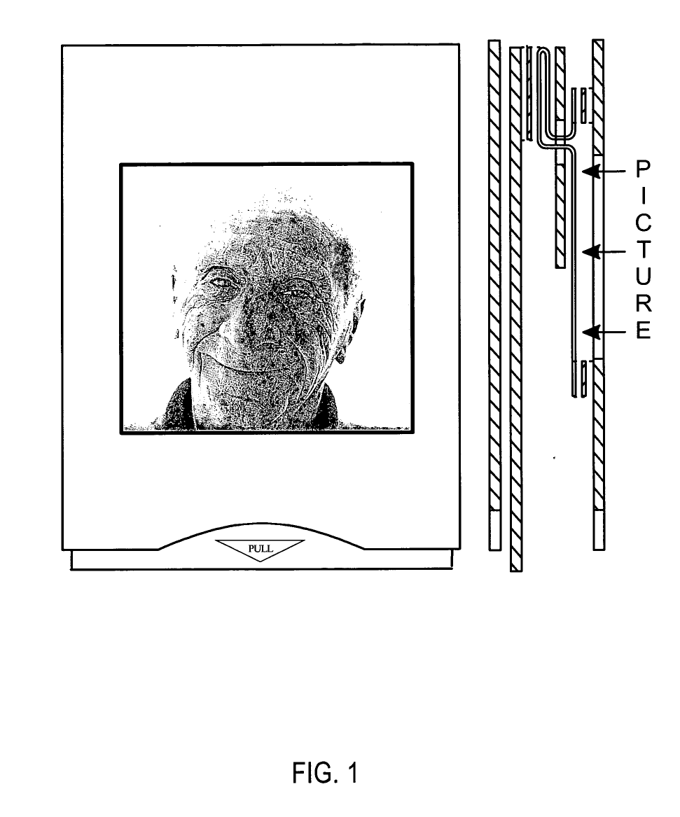

In figure two and correspondent cross section view, the user has pulled the tab that has moved the image sheet down, which has consequently moved the buckle down. Approximately a third of the second image 114 can be seen. The cross section view figure four, shows the hidden portion of the first image and the hidden portion of the second image, which is hidden behind the buckle, between the buckle and the tab. The image sheet is glued or otherwise adhered to the top inside surface of the envelope window 122 and bottom inside surface of the envelope window 124 so that it does not fall out. The image sheet can also be glued to the tab or otherwise adhered to the tab sheet in the same manner such as by double sided tape as seen in FIG. 1 showing the top inside surface of the envelope window 122 and bottom inside surface of the envelope window 124.

In figure three, the user has pulled the tab sheet 130 further so that more than half the initial image has been transformed and scrolled into the second image 114. The further movement of the tab sheet 130 causes further movement in the buckle 150. The further movement in the buckle causes a visual effect where the image interface 888 has moved. Although a user does not see the buckle, the slot in the buckle defines the image interface between the first picture and second picture. This is because the first and second image on the image sheet are constrained in the buckle slot 155.

In figure four, the picture has been fully transformed into the second image 114. The tab sheet 130 is fully extended, pulling the buckle into its lowest position so that the first image is fully hidden and the second image is fully displayed. Although the figures and present embodiment shows a generally straight sheet path, the sheet path can also be adapted to curved or radial configurations.

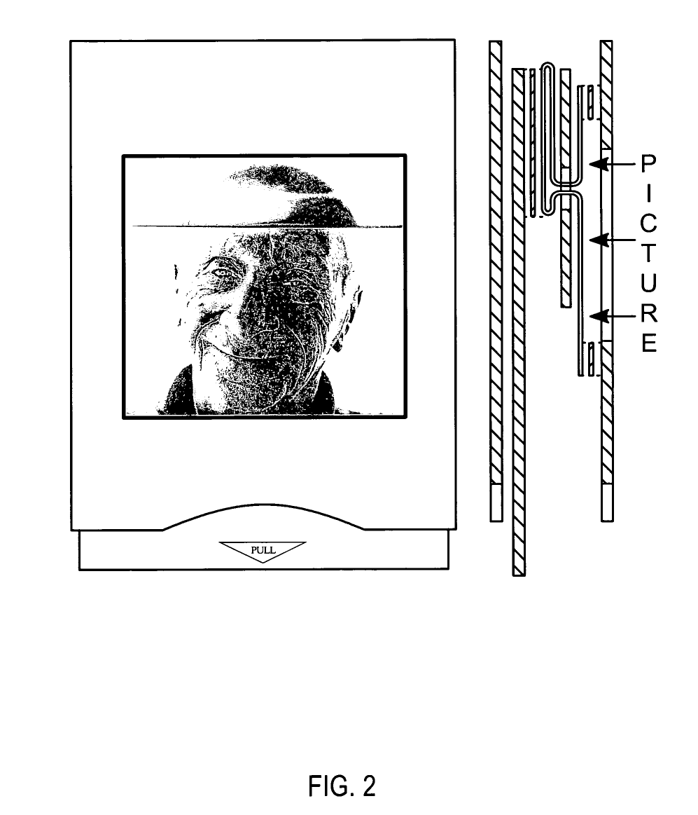

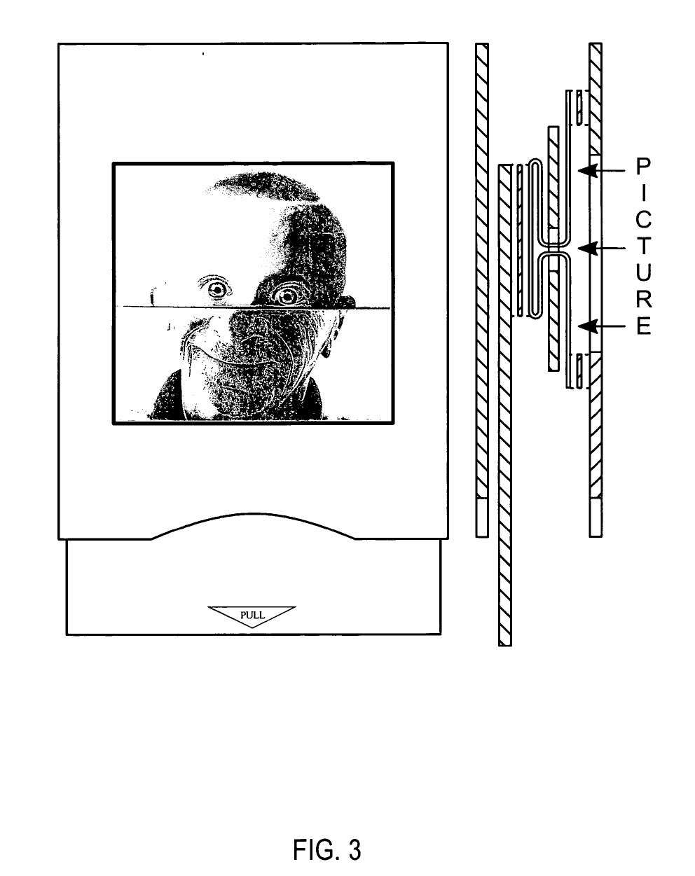

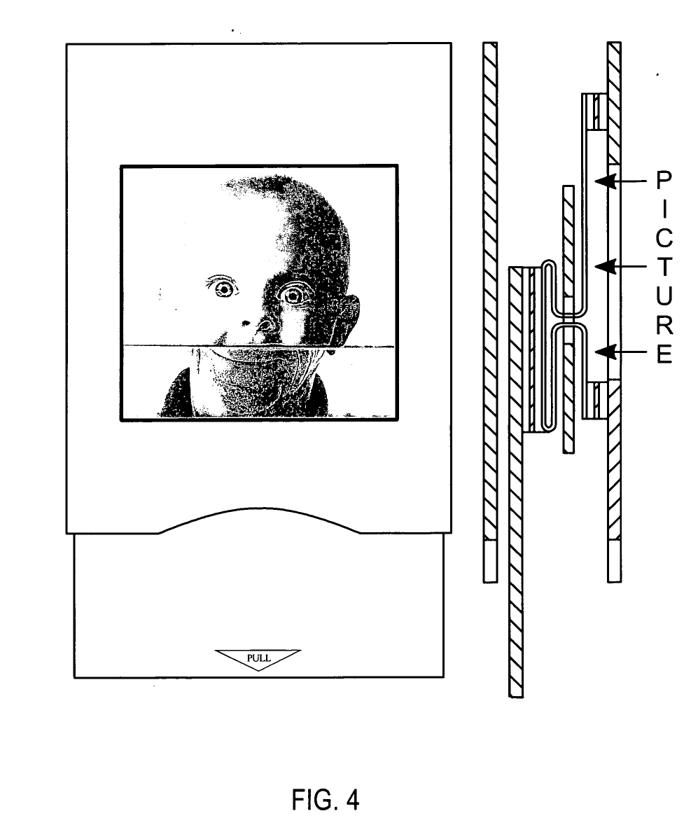

In FIGS. 1 through 4, the detailed description of the preferred embodiment discusses the first embodiment. The second embodiment of the invention is similar to the first embodiment of the invention with one major change. The second embodiment of the invention reverses the function of the buckle and the tab. The second embodiment has the picture glued to the tab sheet 130, but the user does not pull the tab sheet, but instead pulls the buckle member. The buckle member of the second embodiment functions as the tab sheet 130 in the first embodiment and the second embodiment buckle member preferably protrudes from the envelope so that a user can grab it. The second embodiment tab sheet 130 does not protrude from the envelope but is similarly glued to the image sheet in the same manner.

The tab sheet 130 is thus free-floating and not touched by the user. The user pulls on the buckle member so that the buckle member pulls downs on the image sheet that pulls the tab sheet 130 down. In both embodiments, the image sheet is glued in a range to the tab sheet. The range dimensions may vary.

1. A scrolling picture changer comprising:
a. an enveloping member having a window for displaying an image;
b. an image sheet having two images, namely a first image and a second image to be displayed in the window, wherein the image sheet is connected to the inside of the envelope at an image sheet upper end and an image sheet lower end;
c. a buckle with a slot in the buckle, the image sheet passing through the slot, wherein the slot in the buckle defines the image interface between the first image and second image;
d. a tab sheet partially connected to the image member at the middle of the image sheet between the first picture and second picture, wherein a user pulling on the tab will to scroll the picture and transform the first picture to the second picture; wherein when the image is in initial position, only the first image is shown in the window.

2. The scrolling picture changer of claim 1 wherein the scrolling picture changer functions as one of the following: a greeting card, a direct mail advertising piece, a billboard, a trade show booth display.

3. The scrolling picture changer of claim 1 wherein the tab sheet protrudes from the bottom of the envelope so that a user can grab the tab sheet.

4. The scrolling picture changer of claim 1 wherein the tab sheet protrudes from the top of the envelope so that a user can grab the tab sheet.

5. The scrolling picture changer of claim 1 wherein the tab sheet protrudes from the side of the envelope so that a user can grab the tab sheet.

6. The scrolling picture changer of claim 1 wherein the scrolling picture changer is made of paper, plastic or metal.

7. A scrolling picture changer comprising:
a. an enveloping member having a window for displaying an image;
b. an image sheet having two images, namely a first image and a second image to be displayed in the window, wherein the image sheet is connected to the inside of the envelope at an image sheet upper end and an image sheet lower end such that slack in the image sheet allows an image to be shown in the window;
c. a buckle with a slot in the buckle, the image sheet passing through the slot, wherein the slot in the buckle defines the image interface between the first image and second image, wherein a user pulling on the buckle will scroll the picture and transform the first picture to the second picture, wherein when the image is in initial position, only the first image is shown in the window;
d. a free floating tab sheet partially connected to the image member at the middle of the image sheet between the first picture and second picture.

8. The scrolling picture changer of claim 7 wherein the scrolling picture changer functions as one of the following: a greeting card, a direct mail advertising piece, a billboard, a trade show booth display.

9. The scrolling picture changer of claim 7 wherein the buckle protrudes from the bottom of the envelope so that a user can more easily grab the buckle.

10. The scrolling picture changer of claim 7 wherein the buckle protrudes from the top of the envelope so that a user can grab the tab sheet.

11. The scrolling picture changer of claim 7 wherein the buckle protrudes from the side of the envelope so that a user can grab the tab sheet.

12. The scrolling picture changer of claim 7 wherein the scrolling picture changer is made of paper, plastic or metal.

13. A scrolling picture changer comprising:
a. an envelope having a window for displaying an image;
b. an image sheet having two images, namely a first image and a second image to be displayed in the window, wherein the image sheet is inside the envelope connected to the inside of the envelope at an image sheet upper end and an image sheet lower end to display the two images;
c. a buckle having a slot, wherein the buckle is inside the envelope, wherein a middle portion of an image sheet passing through the slot, wherein the slot defines the image interface between the first image and second image;
d. a tab sheet partially connected to the image member, wherein the tab sheet is inside the envelope, wherein moving the tab scrolls the picture between the first image and the second image.

14. The scrolling picture changer of claim 13 wherein the scrolling picture changer functions as one of the following: a greeting card, a direct mail advertising piece, a billboard, a trade show booth display.

15. The scrolling picture changer of claim 13 wherein the tab sheet protrudes from the bottom of the envelope so that a user can grab the tab sheet.

16. The scrolling picture changer of claim 13 wherein the tab sheet protrudes from the top of the envelope so that a user can grab the tab sheet.

17. The scrolling picture changer of claim 13 wherein the tab sheet protrudes from the side of the envelope so that a user can grab the tab sheet.

18. The scrolling picture changer of claim 13 wherein the scrolling picture changer is made of paper, plastic or metal.
